(19) United States
(12) Patent Application Publication
(10) Pub. No.: US 2026/0098738 A1
(43) Pub. Date: Apr. 9, 2026

(54) METHODS AND SYSTEMS FOR DETERMINING ROUTE AND VEHICLE FOR DELIVERING GOODS WITH REDUCED CARBON FOOTPRINT

(71) Applicant: Anteam Ltd, Nottingham (GB)

(72) Inventors: Xiaoqin Ma, Nottingham (GB); Jacob Chapman, London (GB)

(21) Appl. No.: 19/112,671

(22) PCT Filed: Sep. 21, 2023
(86) PCT No.: PCT/IB2023/059338

§ 371 Date: Mar. 18, 2025

(30) Foreign Application Priority Data
Sep. 21, 2022 (GB) 2213776.4

(51) Int. Cl. G01C 21/34; G06Q 10/083

(52) U.S. Cl. CPC G01C 21/3469; G01C 21/3492; G06Q 10/08355

(57) ABSTRACT

Disclosed is a method of determining a route and vehicle(s) for delivering goods, the method comprising steps of: obtaining request from user device of a customer with goods to be delivered from first location to second location; searching for a set of vehicles of journeyers in vicinity of first location and/or en-route to second location and having logistics capacity for goods transportation; determining proposed route for goods delivery, for each vehicle in the set; calculating, using AI model(s), a score for each journeyer who is able to deliver the goods, the score comprising first value calculated based on one or more of simulated data, historical data, and live data for the proposed route, and second value calculated based on carbon emission-related factor(s); determining the route to be used by comparing calculated scores; and matching one or more journeyers on determined route using vehicle(s) with the customer for enabling goods delivery.

### TECHNICAL FIELD

This invention relates to carbon footprint reduction in the goods transportation sector. In particular, though not exclusively, this invention relates to a method of (namely, a method for) determining a route and at least one vehicle for delivering goods, and to a system for determining a route and at least one vehicle for delivering goods.

### BACKGROUND

Over the past few decades, carbon footprint reduction has gained popularity due to environmental awareness in various sectors such as transportation, agriculture, forestry, manufacturing, and the like. Generally, carbon footprint refers to an amount of greenhouse gas (such as carbon dioxide (CO₂), methane, nitrous oxide, and the like) emissions that are caused by an entity (such as an individual, an organisation, a place, a product, and the like). Such emissions are typically greatest in the transportation sector (specifically, road transportation sector). As an example, the transportation sector was responsible for about 25 to 30 percent of total emissions in countries such as the United Kingdom (UK), the United States, the European Union, in the year 2019. In the UK, freight transport was responsible for over 21 percent of total emissions in the year 2019.

Existing known techniques and systems for delivering goods from one location to another location are associated with several limitations. Firstly, the existing techniques and systems make use of dedicated and scheduled delivery transportation and delivery personnel for delivering the goods, for example in a home delivery model. Moreover, with the emergence of e-commerce, for example, online shopping, there is an unprecedented high demand for transportation vehicles, journeys, and available logistics capacities. Resultantly, this has created a considerable negative impact on our environment, such as in the form of a high carbon footprint/CO₂ emissions and traffic congestion. This also adds excess load on our road transportation network.

Secondly, the existing techniques and systems for delivering goods are well-suited to operate with central hubs or distribution centres, whereat the goods are transported from industries and are distributed/delivered to the customers via scheduled deliveries. Thus, a greater number of transportation vehicles, warehousing facilities, logistic capacities, and journeys are required to fulfil the increasing demand of such deliveries, which unnecessarily linearly increases the carbon footprint in the transportation sector. Furthermore, for a conventional logistics network-based delivery, a starting point for the delivery, an end point for the delivery, and timing of each delivery is stringently controlled. This leads to underutilised delivery capacity on the road and wasted return journeys after the delivery, creating an avoidable negative impact on our environment due to inefficiency and waste of resources.

Some existing techniques and systems for delivering goods aim to reduce CO₂ emissions by deploying electric vehicles instead of existing petrol/diesel-based vehicles. However, this requires a large upfront investment and has limitations in terms of mileages and available charging infrastructure. Even if all existing petrol/diesel-based vehicles were to be fully electrified, electricity that would be used to charge the electric vehicles is unlikely to be fully generated by renewable sources within the next decade. Research also shows that electrical vehicles still produce pollution on the road. Therefore, even after switching to electric vehicles, human civilization will still be facing air pollution and traffic congestion problems.

Some existing known models use cyclists for delivering the goods; however, they are limited by physical energy, travel speed and distances to deliver the goods.

Therefore, in light of the foregoing discussion, there exists a need to overcome the aforementioned drawbacks associated with existing techniques and systems for delivering goods.

### SUMMARY OF THE INVENTION

A first aspect of the invention provides a method of (namely, method for) determining a route and at least one vehicle for delivering goods, the method comprising steps of:
obtaining a request from a user device of a customer with goods to be delivered from a first location to a second location;
searching for a set of vehicles of journeyers in a vicinity of the first location and/or en-route to the second location, wherein the set of vehicles have a logistics capacity required for transporting the goods;
determining a proposed route for delivering the goods, for each vehicle in the set, using a geographical map of a region comprising the first location and the second location, and using at least one of: geolocation data, a journey plan, logistics capacity, carbon emission data, of said vehicle;
calculating, using at least one artificial intelligence model, a score for each vehicle of each journeyer who is able to deliver the goods from the first location to the second location, said score comprising a first value and a second value, wherein the first value is calculated based on one or more of simulated data, historical data, and live data for the proposed route, and wherein the second value is calculated based on one or more of: attributes of the vehicle that affect its carbon emissions, historical carbon emissions of the vehicle, a length of the proposed route for the vehicle;
determining the route to be used for delivering the goods by comparing the calculated scores for proposed routes of the vehicles of the set; and
matching one or more journeyers traveling on the determined route using the at least one vehicle with the customer, for enabling delivery of the goods.

The present disclosure provides the aforementioned method for determining a route and at least one vehicle for delivering goods. Herein, the method enables determining a route which is associated with low-carbon emissions for delivering the goods, thereby reducing (for example minimising) a negative environmental impact (especially in a transport sector) by reducing CO₂ emissions/air pollution and traffic congestion. For example, around 90 to 100 percent CO₂ emissions (with a limited detour of the journeyer(s)) could be reduced when the low-carbon emission route which matches delivery requirements (in the customer's request) is implemented for delivery. Moreover, the customer seeking delivery of the goods from the first location to the second location is matched with the one or more journeyers offering their vehicle's spare logistics capacity for delivering said goods via the low-carbon emission route including the first location and the second location. The method enables creating a (geographically and temporally) dispersed logistics network by borrowing existing trips of the one or more journeyers with spare (namely, underutilised) logistics capacity to transport the goods from the first location to the second location, thereby eliminating need for additional dedicated delivery trips which other would have taken place.

In this way, the present invention is capable of helping in decarbonising our physical environment in a consistent manner. Furthermore, the present invention enables generating a rapid growth of logistics capacity for delivering the goods, without heavy upfront investments in warehouses, fleets and other infrastructures that are needed by a conventional logistics network. Moreover, the method allows for delivering the goods from the first location to the second location without unnecessarily travelling via any central hub or distribution centre. The delivery need not occur within a set timing during a day. The dispersed logistics network does not require a conventional logistics infrastructure. The method is effective, robust, reliable and may be implemented with ease.

The request is obtained from a user device of a customer. The request may be received from a software application executing on the user's device, from a software application executing on another device to which the user device is communicably coupled (for example, via an Application Programming Interface (API), and the like).

In some embodiments, the method may comprise obtaining a request from a user device of a customer with goods to be delivered from a first location to a second location, within a pre-defined time limit. For example, the time limit may be defined or set by the quickest time possible for the goods to be delivered from the first location to the second location (i.e. a real-time request). Alternatively, the time limit may be defined or set by a specific time in the future. In other embodiments, the method may comprise obtaining a request from a user device of a customer with goods to be delivered from a first location to a second location, by a predefined time. The predefined time may optionally be an absolute time (for example, such as 8:00 PM, 12:00 AM, or similar) or may be more optionally generalised (for example, such as ‘by today’, ‘in 2 days’, ‘by end of this week’, or similar).

In embodiments in which the method comprises obtaining a request from a user device of a customer with a definition of goods to be delivered from a first location to a second location within a time limit, the step of searching for the set of vehicles of journeyers in the vicinity of the first location and/or en-route to the second location and having a logistics capacity required for transporting the goods, may comprise searching for journeyers in the vicinity of the first location and/or en-route to the second location according to the time limit. Likewise, in other embodiments where the request includes the predefined time by which the goods are to be delivered, the step of searching for the set of vehicles of journeyers may be performed according to the predefined time.

For example, when the time limit is defined by the quickest time possible for the goods to be delivered from the first location to the second location, the method may comprise immediately searching for journeyers in the vicinity of the first location and/or en-route to the second location. When the time limit is defined or set by a specific time in the future (for example, when a current time is 2:00 PM and the request is for delivery of the goods by 6:00 PM, the time limit of 4 hours is set by the specific time of 6:00 PM), the method may comprise searching for predicting journeyers who will be in the vicinity of the first location and/or en-route to the second location at the required time (i.e., the specific time). This may, for example, be based on their planned journeys and/or on their travel patterns learnt by the method (e.g. according to historical and/or simulated data).

Throughout the present disclosure, the “route” which is to be determined by the method, refers to a route for delivering the goods according to journey specifications (i.e., the first location and the second location), with minimal greenhouse gas emissions, and in minimal amount of time with practical considerations. The goods could be grocery items, food items, beverage items, spare parts, e-commerce items, medicines, plants, appliances, and the like. In other words, the goods may be perishable items, non-perishable items, or a combination of these. As an example, from amongst two feasible routes between the first location and the second location, the shorter route may be selected as it may mean that journey time and carbon emissions are lesser on said route, as compared to the longer route. It will be appreciated that the route may not necessarily have minimal emissions of CO₂ as well as minimal delivery time, but may potentially be one which has minimal emissions of CO₂ with respect to customer requirements. This is so because meeting customer requirements with respect to the delivery of goods, and minimizing carbon footprint when making the delivery are both factors that affect the determination of the route. For example, when a given route from amongst a plurality of routes (that are feasible for delivering the goods from the first location to the second location) has lowest emissions of CO₂, but would take a considerably greater amount of time than another route having (slightly) greater emissions of CO₂ as compared to the given route such that delivery time requirements specified by the customer in the request would not be met, the another route could be determined as the route to be used for delivering the goods. This is because, in such a scenario, there may potentially be a trade-off between delivering the goods in minimal amount of time as per the request received from the customer and delivering the goods with minimal emissions of CO₂. Therefore, when another route is determined as the route, the goods could be expeditiously delivered from the first location to the second location, with (slightly) greater emissions of CO₂.

Throughout the present disclosure, the term “first location” refers to a location in a real-world environment wherefrom the goods (of the customer) are to be picked up by a journeyer. In other words, the first location is a pickup location of the goods. Furthermore, the term “second location” refers to a location in the real-world environment whereat the goods (of the customer) are to be delivered by a journeyer. In other words, the second location is a drop-off location of the goods.

The customer could be a single person, a group of persons, an entity (for example, such as a goods retailer, a service provider, a restaurant, a hospital, a private healthcare provider, a charitable clinic, a people/animal shelter, and similar), and the like. The journeyer could be a single person (such as a solo traveler), a group of persons (such as a group of travelers), one or more persons of an entity (for example, such as a logistics fleet operator of a logistics company, a taxi driver of a taxi company, a delivery person of a retailer with own delivery fleet), a drone or an autonomous vehicle, etc. on a given route within the real-world environment. Optionally, the journeyer is travelling on the given route via a vehicle associated with the journeyer. Such a vehicle could be, for example, such as a cycle, a van, a cargo, a truck, a car, a heavy goods vehicle (HGV), a train, a ship, an airplane, and the like. The vehicle could be a private vehicle or a commercial vehicle. Different vehicles could have different logistics capacity for carrying the goods.

It will be appreciated that the request obtained from the customer comprises information pertaining to at least the first location (namely, a pick-up location), the second location (namely, a drop-off location or a delivery point), a type of goods, a quantity of goods, a size of goods, security details for identification. Such a request is obtained from the customer in real time or near-real time (i.e., without any latency/delay) via a text, an audio, and the like. Optionally, the method further comprises providing the customer with an interactive user interface to enable the customer to at least provide the request for delivering the goods from the first location to the second location. The interactive user interface is provided on the user device associated with the customer. Optionally, the interactive user interface is a dedicated user interface pertaining to a software application being executed on the user device associated with the customer. It will be appreciated that the interactive user interface optionally also enables the customer to track the delivery of goods, to contact the journeyer(s) as required, and the like. The user device is optionally a portable device (such as, a smartphone, a smart watch, a tablet computer, a laptop computer, a personal digital assistant, a robot, and the like) or a non-portable device (such as, a desktop-computer, a workstation, a virtual assistant device, a computing device including a server, and the like). Optionally, the user device is communicably coupled to a processor of a system for determining the route and the at least one vehicle for delivering goods. Throughout the present disclosure, the term “processor” refers to hardware, software, firmware or a combination of these. The system is described later in the text, in detail.

It will be appreciated that optionally, the method further comprises obtaining, from a plurality of journeyers with ongoing journeys and/or upcoming journeys, information regarding said journeys (i.e., the ongoing journeys and/or the upcoming journeys) and vehicle information pertaining to said journeys. Such obtaining can be implemented prior to obtaining the request from the user device of the customer, so that there is availability of all journey-related information for implementing further processing steps. The vehicle information may include one or more of identification details of the vehicle being/to be used for said journeys, vehicle registration details, vehicle specifications, vehicle carbon emission data, and the like.

Notably, since the information pertaining to the first location and the second location is accurately known from the request, the journeyers that are near (i.e., in the vicinity of) or will be near at a given time to the first location and/or are travelling towards (i.e., en-route to) the second location, have the logistics capacity required for transporting the goods, are searched by the processor, based on the request. The set of vehicles includes one or more vehicles that match location requirements of goods delivery as well as logistics capacity requirements of goods delivery. It will be appreciated that at any given time, there may be a plurality of vehicles in use in a (geographical) region comprising the first location and the second location, but only some vehicle(s) from amongst the plurality of vehicles may be suited for delivery of the goods, according to the request. Therefore, searching for the set of vehicles is an important technical step involving data processing and data-based decision making.

Optionally, the step of searching for the set of vehicles comprises:
identifying, from amongst the plurality of vehicles, the one or more vehicles in the vicinity of the first location and/or en-route to the second location;
determining, for each vehicle amongst the one or more vehicles, whether said vehicle has the logistics capacity required for transporting the goods; and
when it is determined that said vehicle has the logistics capacity required for transporting the goods, determining said vehicle to belong to the set.

Optionally, the step of identifying, from amongst the plurality of vehicles, the one or more vehicles in the vicinity of the first location and/or en-route to the second location is performed based on at least one of: geolocation data obtained from geolocation devices arranged in the plurality of vehicles, journey plans of the plurality of vehicles, geolocation data obtained from user devices of journeyers to which the plurality of vehicles belong. In this step, only those vehicle(s) that are in the vicinity of the first location and/or en-route to the second location, according to the request, are identified as the one or more vehicles, for further processing.

Optionally, in this regard, the processor is configured to obtain, from a geolocation device arranged on a vehicle or a user device associated with the journeyer, a geolocation data of the vehicle or the user device associated with the journeyer, for each vehicle amongst the plurality of vehicles,. This facilitates the processor to accurately determine which vehicles (and correspondingly, which journeyers) are currently present or are likely to be present in the vicinity of the first location and/or en-route to the second location, as real time or near-real time geolocation data of the vehicle or the user device is readily available to the processor. The user device associated with the journeyer are optionally a portable device, for example, such as a smartphone, a smartwatch, a tablet, a laptop, an infotainment system, and the like. When the geolocation data is obtained from the user device, the user device is typically arranged in the vehicle of the journeyer. Optionally, the system further comprises the geolocation device. Optionally, when a location of a given journeyer lies within their preferred detour distance from the first location, the given journeyer is considered to be in the vicinity of the first location.

Optionally, the one or more vehicles are identified based on the journey plans of the plurality of vehicles. Journey plans are digital travel itineraries of the plurality of vehicles and comprise at least details of upcoming journeys to be undertaken by the plurality of vehicles. For example, a journey plan of a scooter of an employee of a supermarket may comprise details of upcoming journeys such as ‘travel from the supermarket to home at 7:00 PM’, address of the supermarket, address of the home of the employee. It will be appreciated that journey plans may be generated on user devices of journeyers and may be shared with the processor either directly or via an intermediary device (such as a data repository) in real-time (i.e., as they are made), upon receiving a request from the processor, or similar.

Optionally, the one or more vehicles are identified based on the geolocation data obtained from user devices of journeyers to which the plurality of vehicles belong. In such instances, the user devices of journeys may be in proximity of the vehicle and, thus not necessarily arranged in the vehicle. Such geolocation data can also serve as a useful indication of location of vehicles of such journeyers.

Optionally, the step of determining, for each vehicle amongst the one or more vehicles, whether said vehicle has the logistics capacity required for transporting the goods, is performed based on the size and the quantity of the goods, and on at least one of:
an input pertaining to available logistics capacity, said input being received from a user device associated with journeyer of a vehicle belonging to the first set;
sensor data obtained from at least one sensor arranged in said vehicle.

In this regard, the size and the quantity of the goods are indicative of how much storage space is required in a vehicle for transporting the goods. Furthermore, the input pertaining to the available logistics capacity and/or the sensor data are indicative of an actual free storage space availability in the vehicle. It will be appreciated that the vehicle may be carrying other goods besides the goods that are requested to be delivered by the customer, hence the actual free storage space availability in the vehicle can be lesser than a maximum logistics capacity of the vehicle. It is determined that said vehicle has the logistics capacity required for transporting the goods, when the storage space required in the vehicle for transporting the goods is less than or equal to the actual free storage space availability in the vehicle. Thus, the determination of whether said vehicle has the logistics capacity required for transporting the goods is an important consideration for the step of searching for the set of vehicles, since any vehicle which meets the location requirements but does not meet the logistics capacity requirements of goods delivery, is unsuitable for delivering the goods.

Optionally, the at least one sensor comprises at least one of: an image sensor, a weight sensor. The image sensor can be implemented, for example, as a camera, which is arranged in at least one of: an interior region, a boot region, of a vehicle. The camera can be arranged on the vehicle in other ways too, such that it captures images indicative of spatial occupancy of the vehicle, such spatial occupancy being indicative of the actual free storage space availability in the vehicle. The weight sensor can be implemented, for example, as a load cell, a piezoelectric sensor, a strain gauge, an air suspension pressure sensor, and the like, and can be arranged in a suitable part of the vehicle, such as beneath the vehicle's tyres or axles, under a boot region of the vehicle, suspension system of the vehicle, under a floor of the vehicle, and similar. The weight sensor measures a gross weight carries by the vehicle, such as a weight of the vehicle itself, and a weight of load carried by the vehicle (such as weight of people, goods, and the like, in the vehicle).

It will be appreciated that optionally the processor is further configured to search for an additional set of vehicles of journeyers that are en-route to a location in a vicinity of the second location. This is because a given journeyer may not be travelling exactly towards the second location, but rather may be travelling towards the location in the vicinity of the second location. Therefore, the given journeyer may still be able to deliver the goods to the second location (for example, by minimal detouring or rerouting). Optionally, when a given location lies within the journeyer's preferred maximum detour distance from the second location, the given location is considered to be in the vicinity of the second location. It will be appreciated that when the additional set of vehicles is also searched, all processing steps described herein to be performed with respect to the vehicles in the set, are also performed with respect to the vehicles in the additional set.

The proposed route is determined for each vehicle in the set, and these proposed routes are analysed using the at least one artificial intelligence model for eventually determining the route to be employed for delivering the goods. This analysis is performed to determine, from amongst the proposed routes, the route as one which is best suited to meet the location requirements and the logistics capacity requirements of goods delivery, whilst minimizing a carbon footprint associated with the goods delivery. The “proposed route” is a route which is a combination of an original route of the journeyer and a detour that the journeyer is required to take for delivering the goods from the first location to the second location. If the first location and the second location lie along the original route of the journeyer, the detour would be zero, otherwise, there the detour would be required which would make the proposed route different from the original route.

Optionally, the step of determining the proposed route for delivering the goods, for each vehicle in the set, is implemented using at least one route finding software. Such route finding softwares are well known in the art, and alternatively, it may optionally also be a customized route finding software. Optionally, the at least one route finding software processes the geographical map and the at least one of: the geolocation data, the journey plan, the logistics capacity, the carbon emission data, of said vehicle to determine the proposed route. The geographical map is in a computer-readable format. The geolocation data can impact the determination of the proposed route since it is indicative of actual intermediate locations at which the vehicle is present during its journey. The journey plan may potentially impact the determination of the proposed route since it is indicative of tentative intermediate locations at which the vehicle would be present at future time instants during its future journey. The logistics capacity may also potentially impact the determination of the proposed route since there may be mandatory legal and regulatory limits on the logistics capacity, the logistics capacity may be impacted by road infrastructure, and the like. The carbon emissions of the vehicle may impact the determination of the proposed route due to environmental considerations of the carbon emissions (such as emission reduction goals, presence/absence of eco-friendly routes, implementation of emission zones, and the like), regulatory compliances (such as emission standards, emission reporting requirements, and the like), customer preferences, incentives on meeting emission reduction goals, operational efficiency, and the like.

Next, the at least one artificial intelligence model is used to calculate the score for each vehicle of each journeyer who is able to deliver the goods from the first location to the second location. Optionally, prior to the step of calculating the score, the method further comprises: sending a communication to the user device of each journeyer whose vehicle belongs in the set, wherein the communication is indicative of the request of the customer and includes a query as to whether the journeyer is willing to deliver the goods as per the request of the customer; and receiving a response of the journeyer to the query, wherein the response is indicative of the journeyer's willingness or unwillingness to deliver the goods as per the request of the customer.

The score comprises the first value and the second value, wherein the first value is indicative of the suitability of use of the vehicle of the journeyer, in terms of fulfilling the location requirements and the logistics capacity requirements of the request, and wherein the second value is indicative of suitability of use of the vehicle of the journeyer, in terms of reducing (for example minimizing) the carbon footprint associated with fulfilling the request. It will be appreciated that in some instances, calculation of the first value may also take into account one or more attributes associated with carbon emissions of the vehicle, but still the second value is calculated since it expressly indicates the suitability of use of the vehicle of the journeyer, in terms of reducing (for example minimizing) the carbon footprint associated with fulfilling the request. Notably, parameters impacting calculation of the second value are used, optionally, by the at least one artificial intelligence model, to predict carbon emissions (such as CO₂ emissions).

Optionally, the score is a sum of the first value and the second value. Alternatively, optionally, the score is a weighted sum of the first value and the second value. In this regard, the weights may lie in a range of 0 to 1, with a (relatively) higher weight meaning that its corresponding value (the first value or the second value) has a higher impact on the score, as compared to a (relatively) smaller weight. For example, the score may be determined as 0.5*first value+0.5*second value, when both the first and second values have an equal impact on the score. In another example, the score may be determined as 0.6*first value+0.4*second value, when the first value has a higher impact on the score than the second value.

Notably, when the first value (which is a constituent of the score) for a given journeyer is calculated based on the simulated data, certain factors (for example, such as a detour distance, a total time taken for delivering the goods, CO₂ emissions, and the like) may be considered by the processor after performing a simulation. The simulation may be performed by an artificial intelligence model that is pre-trained to perform such simulations. The simulation involves digitally estimating an outcome of what happens when the given journeyer is to switch from a route on which the given journeyer is currently present to the proposed route (which is an expected route (namely, a simulated route) of the given journeyer for picking and delivering the goods. The simulated route may be determined from simulation results (i.e., an output of the simulation) in the simulated data, as described herein later in detail. In an example, greater the detour distance, lower is the first value of the score. In another example, lower the CO₂ emissions, greater is the first value of the score. In yet another example, greater a travel time on the proposed route, lower is the first value of the score. Optionally, the method further comprises training the artificial intelligence model using at least one artificial intelligence algorithm and annotated first training data that is similar to the simulated data which the artificial intelligence model would be required to process upon training. In this regard, annotations comprise first values corresponding to first training data.

Additionally or alternatively, when the first value (which is a constituent of the score) for a given journeyer is calculated based on the historical data, information (for example, such as a journeyer rating, CO₂ emissions, a tip amount, and the like) pertaining to trips of the journeyer that have already happened between the first location and the second location in past may be considered by the processor. The calculation of the first value based on the historical data may be performed by an artificial intelligence model that is pre-trained to perform such calculations. In an example, greater the journeyer rating in past trip(s), greater is the first value of the score. In another example, lower the CO₂ emissions in past trip(s), greater is the first value of the score. Optionally, the method further comprises training the artificial intelligence model using at least one artificial intelligence algorithm and annotated second training data that is similar to the historical data which the artificial intelligence model would be required to process upon training. In this regard, annotations comprise first values corresponding to second training data.

Yet additionally or alternatively, when the first value (which is a constituent of the score) for a given journeyer is calculated based on the live data, up-to-date (i.e., real time or near-real time) information (for example, pertaining to weather, a road-block, a containment zone, and the like) collected from the customer and/or the journeyer may be considered by the processor. The calculation of the first value based on the live data may be performed by an artificial intelligence model that is pre-trained to perform such calculations. The containment zones may include pandemic or epidemic affected areas in the real-world environment. In an example, when there is a road-block or a containment zone on a route of the journeyer, a detour distance of the journeyer may be high (i.e., greater than a route without the road-block or the containment zone), and thus the first value of the score may be low. In another example, when the weather of a location on a route of the journeyer is rainy, there may potentially be traffic congestion and delivery time may be high, and thus the first value of the score may be low. Optionally, the method further comprises training the artificial intelligence model using at least one artificial intelligence algorithm and annotated third training data that is similar to the live data which the artificial intelligence model would be required to process upon training. In this regard, annotations comprise first values corresponding to third training data.

Optionally, the first value lies in a range of 0 to 1. Similarly, optionally, the second value lies in a range of 0 to 1. It will be appreciated that there may potentially be other feasible ranges for the first value and the second value, such as 0 to 10, 0 to 100, and the like. Accordingly, a range of a score for a given vehicle of a given journeyer would be affected. Said range is also affected by presence or absence of weights during calculation of said score.

Optionally, a score for a given vehicle of a given journeyer lies in a range of 0 to 1. Herein, a value 0 indicates a lowest score, while a value 1 indicates a highest score. For example, the score may be in a range of from 0 to 0.5, or from 0 to 0.6, or from 0 to 0.8, or from 0 to 1, or from 0.1 to 0.5, or from 0.1 to 0.6, or from 0.1 to 0.8, or from 0.1 to 1, or from 0.2 to 0.5, or from 0.2 to 0.6, or from 0.2 to 0.8, or from 0.2 to 1, or from 0.4 to 0.5, or from 0.4 to 0.6, or from 0.4 to 0.8, or from 0.4 to 1, or from 0.7 to 0.8, or from 0.7 to 1. Alternatively, optionally, a score for a given vehicle of a given journeyer lies in a range of 0 to 2. Yet alternatively, optionally, a score for a given vehicle of a given journeyer lies in a range of 0 to 100. Herein, a value 0 indicates lowest score, while a value 100 indicates highest score. For example, the score may be in a range of from 0 to 50, or from 0 to 60, or from 0 to 80, or from 0 to 100, or from 10 to 50, or from 10 to 60, or from 10 to 80, or from 10 to 100, or from 20 to 50, or from 20 to 60, or from 20 to 80, or from 20 to 100, or from 40 to 50, or from 40 to 60, or from 40 to 80, or from 40 to 100, or from 60 to 80, or from 80 to 100. It will be appreciated that other ranges for expressing the score may also be feasible.

Optionally, the simulated data comprises simulation results of the proposed route of the vehicle of the journeyers from the first location to the second location for delivering the goods. It will be appreciated that the simulated results provide the processor with statistics pertaining to certain factors (mentioned hereinbelow) associated with said proposed route. Such statistics are important to consider when calculating the first value of the score for the journeyer because information on how the journeyer would perform on the expected route could be known from the simulation results. Beneficially, in such a case, the calculated first values (and consequently, the calculated scores) for the vehicles of the journeyers are accurate and reliable. Optionally, the simulation results of the expected route comprise at least one of: a detour distance, a detour time, a total time taken for delivering the goods, CO₂ emissions, a total distance travelled for delivering the goods.

Optionally, the simulated data is generated by performing a simulation, wherein a random latitude and longitude generator is used for producing the first location and the second location within the simulation. The aforesaid locations may, for example, be 9 kilometres far away from a centre of a map of the real-world environment. Furthermore, a route-finding software is used for producing various feasible routes (i.e., proposed routes) of the journeyers from the first location to the second location. Such routes along with the journeyers may optionally be arranged in batches as per a given order, and statistics for each route may be ascertained.

Optionally, the historical data comprises attributes of trips made between the first location and the second location in the past. It will be appreciated that the historical data provides information pertaining to trips that have already happened between the first location and the second location in the past. Such information beneficially facilitates in determining the score accurately and reliably as information on how journeyers (travelling between the first location and the second location) had performed in their past trips, is readily and already known to the processor, and likelihood of deviation of attributes of the past trips is considerably low.

Optionally, an attribute of a trip between the first location and the second location in the past is at least one of: latitude and longitude information for a given location, a pick-up time, a drop-off time, a passenger count, journeyer details, a distance between the first location and the second location, a journey time, fare per unit distance, a mode of payment, a service tax amount, a tip amount, a toll amount, a surcharge amount, a congestion charge amount, a journeyer rating, a customer rating, CO₂ emissions, a route followed for a past trip.

Optionally, the live data comprises real-world live information received from the user device of the customer and/or user devices of the journeyers that may potentially impact the route determination. It will be appreciated that the live data provides the processor with an up-to-date real-world live information collected from the customer and/or the journeyers. Such information is important to consider when calculating the score because it may potentially directly affect the route to be taken by the journeyer for delivering the goods. Beneficially, in such a case, the calculated score is highly accurate and reliable.

Optionally, the real-world live information comprises at least one of: an amount of CO₂ saving for previous trips, a total time taken for delivering the goods, a pick-up time, a drop-off time, a passenger count, journeyer details, a journey time, a detour time, a detour distance, a type of transport and its associated CO₂ emissions, a distance between the first location and the second location, a journeyer rating, a customer rating, preferences or behaviour patterns of a journeyer, preferences or behaviour patterns of a customer, a category of the goods, a weight of the goods, a size of the goods, a current location of the journeyer, fare per unit distance, a mode of payment, a service tax amount, a tip amount, a toll amount, a surcharge amount, a congestion charge amount, weather conditions, information pertaining to an accident, a containment zone, a road block. A mode of transport that may be used may include at least one of land, water, air or a combination of any of the aforesaid modes. The type of transport may optionally be a manned or an unmanned road vehicle (such as a van, a cargo, a truck, a car, an autonomous vehicle and the like), a train, a ship, an airplane, a drone, a bicycle, and an active travel, or similar. The active travel may include cycling, walking, micromobility vehicles, and the like. The category of the goods may include perishable goods, non-perishable goods, fragile goods, chemical goods, flammable goods, or similar.

The second value is indicative of environment impact of the vehicle if it travels on the proposed route. Optionally, the attributes of the vehicle that affect its carbon emissions comprise one or more of: an engine type, a fuel efficiency, a size, a weight, a transmission, aerodynamics, a tire efficiency, a drive system, an age, a state of maintenance, an idle time, an emissions control system, use or non-use of alternative fuels, a driving pattern, a cargo load, a speed, a usage of air conditioning and heaters, electrical accessories, of the vehicle. For example, a second value for a fully electric vehicle may be higher than a second value for a gasoline engine, since fully electric vehicles (EVs) produce zero tailpipe CO₂ emissions unlike gasoline engines. In another example, a second value for a newer vehicle (i.e., a vehicle that has a relatively smaller age) is higher than a second value for an older vehicle (a vehicle that has relatively larger age). Optionally, the calculation of the second value based on the attributes of the vehicle that affect its carbon emissions is performed by an artificial intelligence model that is pre-trained to perform such calculations. Optionally, in this regard, the method further comprises training the artificial intelligence model using at least one artificial intelligence algorithm and annotated fourth training data comprising reference values of said attributes and corresponding second values.

Optionally, the historical carbon emissions of the vehicle may depend on a historical value of at least one of the attributes of the vehicle that affect its carbon emissions. Generally, higher the historical carbon emissions, lower the second value, and vice versa. The historical carbon emissions of the vehicle may be pre-known, or may be determined by an artificial intelligence model that is pre-trained to determine them based on historical values of at least one of the attributes of the vehicle that affect its carbon emissions. Optionally, the method further comprises training the artificial intelligence model using at least one artificial intelligence algorithm and annotated fifth training data comprising said historical values of the at least one of the attributes and corresponding historical second values.

Optionally, greater the length of the proposed route for the vehicle, smaller is the second value, and vice versa. Optionally, an artificial intelligence model is pre-trained to determine the second value based on the length of the proposed route. Optionally, the method further comprises training the artificial intelligence model using at least one artificial intelligence algorithm and annotated sixth training data comprising historical lengths of routes taken by the vehicle and corresponding historical second values.

Optionally, the method further comprises determining a reward function when calculating the score, wherein the reward function corresponds to one or more factors impacting the route determination. It will be appreciated that the “reward function” is a function which ascertains that when a given journeyer takes a detour from his/her present route for delivering the goods as per customer's requirement, what type of benefits/values it generates. It will be appreciated that different benefits of the reward function are optionally generated for different journeyers. Optionally, the reward function impacts the calculation of the score. In this regard, the score optionally further comprises a third value that is calculated based on values of the one or more factors corresponding to the reward function. Furthermore, optionally, the score is calculated based also on the third value. Optionally, the reward function is utilized to generate at least one of: credits, reward points, discount coupons, for the journeyer, upon delivery of the goods by said journeyer. These at least one of: credits, reward points, discount coupons, may be utilized by the journeyer in buying goods and/or transporting goods as customers. It will be appreciated that when the score is optionally calculated further based on the reward function, values of the one or more factors are considered to ascertain how the one or more factors affect the proposed route (i.e., how much emissions of CO₂ and how much amount of time is required for the delivery of goods via said proposed route).

Optionally, the one or more factors comprises CO₂ emissions, CO₂ pricing, service ratings, delivery time, logistics capacity, and social distancing measures. It will be appreciated that different weights (for example, in a range of 0 to 1) could be assigned to the one or more factors, based on a given preference. Such a preference may be either system defined, or user defined. In an example, when a perishable good (such as a frozen meat) is to be delivered from the first location to the second location, the delivery time may be assigned a higher weight as compared to the CO₂ emissions.

The term “social distancing measure” refers to a physical distance (typically, equal to or greater than 2 metres (i.e., greater than circa 6 feet)) between two or more persons in order to keep a safe space between them. The social distancing measures are introduced during a medical exigency, for example, such as Covid-19 pandemic. The social distancing measures may also include no-contact greetings, no-contact delivery of goods, and the like. In an example, better conformance of the social distancing measures and/or greater the service ratings, greater is the third value (which may be a constituent of the score).

In another example, lesser the CO₂ emissions, the CO₂ pricing, and the delivery time, greater is the third value (and additionally, optionally, the score). In yet another example, when the available logistics capacity (namely, an amount of a physical space available with the journeyer to carry the goods for delivery) is equal to or greater than a required logistics capacity for transporting the goods, the available logistics capacity is determined to be optimal (i.e., adequate) as per a quantity of the goods to be delivered, and thus the third value (and optionally, the score) may be high. Such a physical space is optionally a boot space in a vehicle associated with the journeyer, a carrying bag of the journeyer, or similar.

Optionally, when determining the route, the processor is configured to utilize in a decreasing order of priorities one or more of: the proposed route (i.e., an expected route) of a journeyer having a highest score, the proposed route (i.e., an expected route) of a journeyer having a second highest score, the proposed route (i.e., an expected route) of a journeyer having a third highest score, and so on. In this regard, the route is derived by using at least one proposed route (i.e., at least one expected route) of journeyers having high scores so that the goods are delivered with minimal emissions of CO₂ and in minimal amount of time, with respect to customer requirements.

Optionally, the route to be used for delivering the goods is determined as one of the proposed routes. Alternatively, optionally, the route to be used for delivering the goods is determined as a combination of two or more proposed routes. This may happen when the combination of the two or more proposed routes meets delivery requirements better (i.e., more suitably) and/or has higher carbon emission savings as compared to any single proposed route.

In an example, the scores of three journeyers A1, A2, and A3 may be 0.9, 0.25, and 0.45, respectively. Herein, the route may be determined as a proposed route (i.e., an expected route) of the journeyer A1 having a highest score. In another example, scores of four journeyers B1, B2, B3, and B4 may be 0.2, 0.65, 0.7, and 0.4, respectively. Herein, the route may be derived by using proposed routes (i.e., expected routes) of the journeyers B2 and B3. For example, the route may be determined to be a combination of the proposed routes of the journeyers B2 and B3, such one journeyer amongst the journeyers B2 and B3 transports the goods from the first location to an intermediate location on the route, and the other journeyer amongst the journeyers B2 and B3 transports the goods from the intermediate location to the second location. Optionally, the intermediate location may be a location that lies on the proposed routes of both the journeyers B2 and B3. In yet another example, scores of three journeyers C1, C2, C3, and C4 may be 0.1, 0.24, 0.55, and 0.5, respectively. Herein, the route may be derived by using expected routes of the journeyers C3 and C4.

It will be appreciated that the at least one artificial intelligence model predicts suitability of each journeyer for delivering the goods according to the request with nil or minimal carbon emissions, by calculating the scores for each journeyer, wherein a high score is indicative of high suitability of the journeyer for delivering the goods, and vice versa. In other words, the at least one artificial intelligence model predicts pairing solutions between customers and journeyers. Optionally, the at least one artificial intelligence model used for calculating the score for each vehicle of each journeyer who is able to deliver the goods from the first location to the second location, comprises a multilayer perceptron feedforward artificial neural network. The multilayer perceptron feedforward artificial neural network may comprise an input later, two hidden layers, and an output layer, wherein rectified linear activation functions may be used between the two hidden layers. The final output layer may have a softmax activation to allow for choosing the best journeyer for the goods delivery. As an example, dropout may be used as a regularisation methodology. Optionally, data set fed to the at least one artificial intelligence model is normalised using a standard scaler to stop the weights of the neural network exploding. Optionally, annotations of a given training data are made by a human, using human intelligence. Optionally, the at least one artificial intelligence model has a high F1 score. The F1 score can be interpreted as a weighted average of precision and recall, where an F1 score reaches its best value at 1 and worst score at 0. It will be appreciated that the above optional implementation of the at least one artificial intelligence model is not the only feasible implementation associated with embodiments of the present disclosure, and other suitable implementations of artificial intelligence models are well within the scope of the present disclosure. For example, artificial intelligence models which do not utilise feedforward approaches may also be used for calculating the score for each vehicle of each journeyer who is able to deliver the goods from the first location to the second location.

Once the route is determined, the one or more journeyers traveling on the determined route are matched (namely, associated and connected) with the customer for delivering the goods. Optionally, the method further comprises providing the one or more journeyers with an interactive user interface to enable the one or more journeyers to at least receive the request from the customers for delivering the goods from the first location to the second location. It will be appreciated that the request can be received in form of a push notification, a graphical notification, a text notification, an audio notification, and the like. The interactive user interface may also enable the one or more journeyers to communicate with the customer as and when required, respond to a request, and the like. The interactive user interface is provided on the user device associated with the one or more journeyers.

In one example scenario, a single journeyer is matched with the customer for delivering the goods from the first location to the second location. In such a case, the single journeyer would entirely follow the determined route for delivering the goods. In another scenario, multiple journeyers may be matched (i.e., are to be employed) for delivering the goods from the first location to the second location. In such a case, a first journeyer delivers the goods from the first location to an intermediate location between the first location and the second location, and hands over the goods to a second journeyer (at the intermediate location) who would deliver said goods from the intermediate location to the second location. Herein, two journeyers (i.e., the first journeyer and the second journeyer) would partly follow the determined route for delivering the goods. It will be appreciated that the method facilitates in a rapid delivery of the goods at a nil or low competitive cost for the customers, whilst contributing towards reduction of CO₂ emissions or any other factors that may negatively impact sustainability or the real-world environment.

In an example, a journeyer who is working at a grocery superstore may be matched with a customer who lives in a surrounding area of the journeyer. In such a case, during a return journey of the journeyer, the journeyer may collect, using the journeyer's vehicle, and deliver an item requested by the customer. In another example, a journeyer who is travelling towards a retail park to buy something for themselves may be matched with a customer who lives in a surrounding near the journeyer. In such a case, during a return journey of the journeyer, the journeyer may, using the journeyer's vehicle, collect and deliver (within a limited amount of detour) an item from a particular store in the (same) retail park, as requested by the customer.

It will be appreciated that the one or more journeyers on the determined route are beneficially matched with the customer for delivering the goods by way of employing deterministic algorithm(s) and/or stochastic algorithm(s).

Optionally, the method further comprises interpreting the simulated data, the historical data, and the live data to learn their impact on route determination and train at least one artificial intelligence model using the learnt impact and at least one artificial intelligence algorithm to suggest at least one route between the first location and the second location. The determined route may optionally be from amongst the at least one route suggested by the at least one artificial intelligence model or a combination of two or more routes from amongst a plurality of routes suggested by the at least one artificial intelligence model. The suggestion of a given route is indicated by its score. The at least one route is understood to be suggestive since it is optionally determined based only on interpretation of the simulated data, the historical data, and the live data, and not on any parameter(s) that impacts calculation of the second value. If the method optionally further comprises interpreting such parameter(s) and to learn their impact on route determination and trains the at least one AI model using said impact and the at least one AI algorithm, the at least one AI model accurately determines the route and the at least one vehicle for delivering the goods. It will be appreciated that when the simulated data, the historical data, and the live data are interpreted, semantically meaningful and informative labels (for example, in a form of notes, comments, descriptions, and the like) are assigned to said data for the at least one artificial intelligence (AI) model to learn and get trained. The aforesaid data along with the labels are provided as a training dataset to the at least one AI model for recognizing certain types of patterns in said data. Optionally, in this regard, the at least one AI model employs at least one artificial intelligence algorithm (such as at least one machine learning algorithm) for learning from the interpreted data. The at least one machine learning algorithm is optionally one of: a k-nearest neighbours algorithm, a linear regression algorithm, a k-means algorithm, a logistic regression algorithm, a decision tree algorithm, a Naïve-Bayes algorithm. Such algorithms are well-known in the art. Training the at least one AI model in the aforesaid manner facilitates in the trained AI model to accurately determine the route for future journeys with a minimal (or near zero) error. The learning of the AI model is optionally a supervised learning, unsupervised learning, a semi-supervised learning, or a reinforcement learning. As an example, an AI algorithm that is optionally used is a supervised machine learning algorithm applied to an Artificial Neural Network (ANN). It will be appreciated that the AI model is trained to match potential customers'requests for delivering goods with journeyers that are able to pick-up and deliver the goods as part of their day-to-day commutes.

Optionally, the method further comprises providing, at a user device of the journeyer, additional requests from the user device of the customer that may potentially impact the route taken by the journeyer. In this regard, the customer may send the additional requests to the journeyer so that a route taken by the journeyer may have reduced (for example, minimal) emissions of CO₂ and/or the journeyer could reach to the first location and/or the second location in a reduced (for example, minimal) amount of time. In this manner, such additional requests are suitable with lower sustainability and/or environmental impact to the real-world environment. The additional requests may be relevant to a current location of the journeyer, or to a previous trip of the journeyer. Optionally, the additional request from the customer comprises at least one of: a suggestion for taking a particular route for detouring, a suggestion for picking up the goods in a particular time slot of a day, buying an additional item en-route for delivery.

Optionally, the method further comprises observing an environmental impact of the determined route by monitoring sensor data captured by a plurality of sensors, while the at least one vehicle travels on the route for delivering the goods. In this regard, environmental changes resulting from an implementation of the determined route for delivering the goods are observed in order to ascertain how beneficial the determined route is, for example, such as in terms of reducing air pollution (i.e., CO₂ emissions), traffic congestion, and the like. It will be appreciated that, in such a case, the plurality of sensors are optionally arranged in the at least one vehicle associated with the determined route to sense actual emissions by the at least one vehicle and/or in the real-world environment to sense levels of air pollution, traffic congestion, and the like for observing the environmental impact of the determined route. The plurality of sensors may comprise air pollution sensors, cameras (i.e., image sensors), particulate matter sensors, temperature sensors, smoke sensors, and the like.

Optionally, the method further comprises recording the observed environmental impact to improve the calculation of the second value that impacts the route determination for future journeys. In this regard, the observed environmental impact is used as feedback to improve the route determination for the future journeys. For example, when the observed environmental impact (for example, a level of pollution or CO₂ emissions) is not sufficient and can be improved, a next route may be determined (for future journeys) with an improved/different strategy, for example, by considering and weighing different factors in the simulated data, the historical data, and/or the live data in different manner (than earlier). Optionally, information pertaining to the observed environmental impact is stored in a memory (i.e., a data repository) communicatively coupled to the processor.

Optionally, the method further comprises:
obtaining journeyer attributes;
obtaining customer attributes;
creating artificial intelligence models through selecting different algorithms, parameters, hyperparameters, and variables, wherein an evolutionary algorithm is used when selecting different hyperparameters of the AI models; and
continually training the artificial intelligence models to perform at least one of: suggest at least one route between the first location and the second location, suggest the one or more journeyers for matching with the customer.

Optionally, when training the AI models, for each training cycle, data pertaining to the journeyer attributes and/or the customer attributes are fed into the AI models. With each training cycle, the AI models are trained to predict (i.e., suggest) the route and the one or more journeyers to match with the customer. By predicting the route for delivering the goods, the AI models also suggest/determine the at least one vehicle for delivering the goods. The parameters for the models (i.e., weights and coefficients that the AI models extract from the data) are optionally adjusted to ensure that the predictions are accurate and reliable, with each training cycle. The hyperparameters are settings and configurations that are not learned from the data but are set (for example, by a machine learning engineer or researcher) before training begins. Hyperparameters are optionally adjusted for improving AI model predictions, as they control various aspects of the training process, model architecture, and optimization algorithm. It will be appreciated that different variables for the AI models are optionally also adjusted for improving the predictions, and thus the aforesaid training step is repeated. The algorithm(s) selected for creating the AI models are verified by taking validation data against the trained AI model(s). When the algorithm(s) is/are passed in a validation stage, the AI models may be beneficially tested with real-world data to ascertain whether or not a given algorithm is ready to be used for determining the route and/or matching the one or more journeyers on the determined route with the customer. The algorithms are optionally deterministic AI algorithms or stochastic AI algorithms; the algorithms are optionally implemented on a Boltzmann machine, a Born machine or similar.

The AI models may be trained for a period of time until a reasonable outcome can be achieved by employing the AI models for said determination. In this regard, a reasonable outcome is achieved when a training accuracy increases and a validation accuracy steadily decreases, or when the training accuracy seems to be constant or fluctuate around a certain value, or when rewards are maximised and reach a point of stability. Thus, the aforementioned steps may be optionally repeated at any time when the AI model(s) is/are to be updated either automatically after a predetermined time period, or manually as and when required.

It will be appreciated that selecting different hyperparameters (i.e., tuning hyperparameters) of neural networks of the AI models may potentially add significant improvement to the system. As mentioned above, optionally, the evolutionary algorithm is used when selecting different hyperparameters of the AI models. The population of individual AI models is re-created in each training cycle with slightly tweaked hyperparameters, the AI models are run, a set of few best models (for example a set of 3 best models) is selected and paired, and the parameters are tweaked again. This process is repeated a plurality of times (for example, 10 times), so that the evolutionary algorithm converges to the best result in a small number of trials. A technical effect of this approach is that the evolutionary algorithm provides significant improvement over the traditional grid search approach (since grid search attempts every combination of values to find the best set of parameters, it is computationally expensive). The evolutionary algorithm on the other hand, beneficially attempts far fewer combinations while evolving towards the best hyperparameters, and this skips the worst performing configurations. In this way, the evolutionary algorithm is more efficient than grid search, especially with respect to time and/or cost constraints.

The term “journeyer attribute” refers to a piece of information (such as a characteristic) related to a journeyer. Optionally, the journeyer attributes comprise planned journeys, transport type, past locations, vehicle information, logistics capacity, and preferences of the journeyer. The preferences of the journeyer may include information pertaining to locations that the journeyer prefers to go to, a weight of the goods that the journeyer prefers to carry and deliver, a type of the goods the journeyer prefers not to carry, maximum detour distance and/or time and the like. The vehicle information may include information pertaining to the vehicle of the journeyer, such as vehicle identification details, vehicle purchase details, vehicle registration details, vehicle specifications, vehicle performance data, vehicle images, vehicle carbon emission data, and the like. The term “customer attribute” refers to a piece of information related to a customer. Optionally, the customer attributes comprise requested journeys, past locations, preferences, demographic data and historical records. The preferences of the customer nay optionally be a preference of vehicle, a way in which the customer wants the goods to be carried by the journeyer, a particular pick-up time (for example, morning, evening, weekends, or holidays). The demographic data may include, for example, such as, age, ethnicity, gender, marital status, and the like.

A second aspect of the invention provides a system for determining a route and at least one vehicle for delivering goods, the system comprising:
a data memory;
a communication module that is configured to communicate with a user device of a customer and with user devices of journeyers; and a processor configured to:
   obtain a request from the user device of the customer with goods to be delivered from a first location to a second location;
   search for a set of vehicles of journeyers in the vicinity of the first location and/or en-route to the second location and having a logistics capacity required for transporting the goods;
   determine a proposed route for delivering the goods, for each vehicle in the set, using a geographical map of a region comprising the first location and the second location, and using at least one of: geolocation data, a journey plan, logistics capacity, carbon emission data, of said vehicle;
   calculate, using at least one artificial intelligence model, a score for each vehicle of each journeyer who is able to deliver the goods from the first location to the second location, said score comprising a first value and a second value, wherein the first value is calculated based on one or more of simulated data, historical data, and live data for the proposed route, and wherein the second value is calculated based on one or more of: attributes of the vehicle that affect its carbon emissions, historical carbon emissions of the vehicle, length of the proposed route for the vehicle;
   determine the route to be used for delivering the goods by comparing the calculated scores for proposed routes of the vehicles of the set; and
   match one or more journeyers traveling on the determined route using the at least one vehicle with the customer, for enabling delivery of the goods.

Throughout the present disclosure, the term “memory” refers to hardware, software, firmware, or a combination of these for storing a given information in an organized (namely, structured) manner, thereby, allowing for easy storage, access (namely, retrieval), updating and analysis of the given information. Examples of the memory, include but are not limited to, random access memory, hard disk drive, flash memory, and optical disc.

Throughout the present disclosure, the term “communication module” refers to hardware, software, firmware, or a combination of these for at least obtaining the request from the customer. It will be appreciated that the communication module is associated with a communication network via which the user device associated with the customer is communicably coupled to the processor. Such a communicable coupling may be wired, wireless, or a combination thereof. Examples of the communication network may include, but are not limited to, Internet, a local network (such as, a TCP/IP-based network, an Ethernet-based local area network, an Ethernet-based personal area network, a Wi-Fi network, and the like), Wide Area Networks (WANs), Metropolitan Area Networks (MANs), a telecommunication network, and a radio network.

Notably, the processor controls an overall operation of the system. The processor is communicatively coupled to the memory via the communication module. The aforementioned processing steps performed by the processor have already been described above.

A third aspect of the invention provides a computer program comprising instructions which, when the program is executed by a computer, cause the computer to carry out steps of the aforementioned first aspect.

Throughout the present disclosure, the term “computer program” refers to a software comprising program instructions that are recorded on a non-transitory machine-readable data storage medium, wherein the software is executable upon a computer (namely, a processing device) for implementing the aforementioned steps of the method of determining the route and the at least one vehicle for delivering goods.

The program instructions stored on the non-transitory machine-readable data storage medium are able to direct the computer to function in a particular manner, such that the computer executes processing steps of determining a route and at least one vehicle for delivering goods. Examples of the non-transitory machine-readable data storage medium includes, but are not limited to, an electronic storage device, a magnetic storage device, an optical storage device, an electromagnetic storage device, a semiconductor storage device, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination thereof.

Throughout the present disclosure, the term “computer” refers to a device that is capable of processing the program instructions of the computer program. The computer may, for example, comprise a microprocessor, a microcontroller, a processing unit, or similar.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the following diagrams wherein:

FIG. 1 is an illustration of a flow chart including steps of a method for determining a route and at least one vehicle for delivering goods, according to an embodiment of the present disclosure;

FIG. 2 is an illustration of a block diagram of an architecture of a system for determining a route and at least one vehicle for delivering goods, according to an embodiment of the present disclosure;

FIG. 3 is an illustration an exemplary scenario of using a method for determining a route and at least one vehicle for delivering goods, according to an embodiment of the present disclosure;

FIG. 4 illustrates an exemplary process flow for learning and training at least one artificial intelligence model to determine a route and at least one vehicle for delivering goods, according to an embodiment of the present disclosure; and

FIG. 5 is an illustration of an experimental use-case scenario of using a method for determining a route and at least one vehicle for delivering goods, according to an embodiment of the present disclosure.

### DETAILED DESCRIPTION

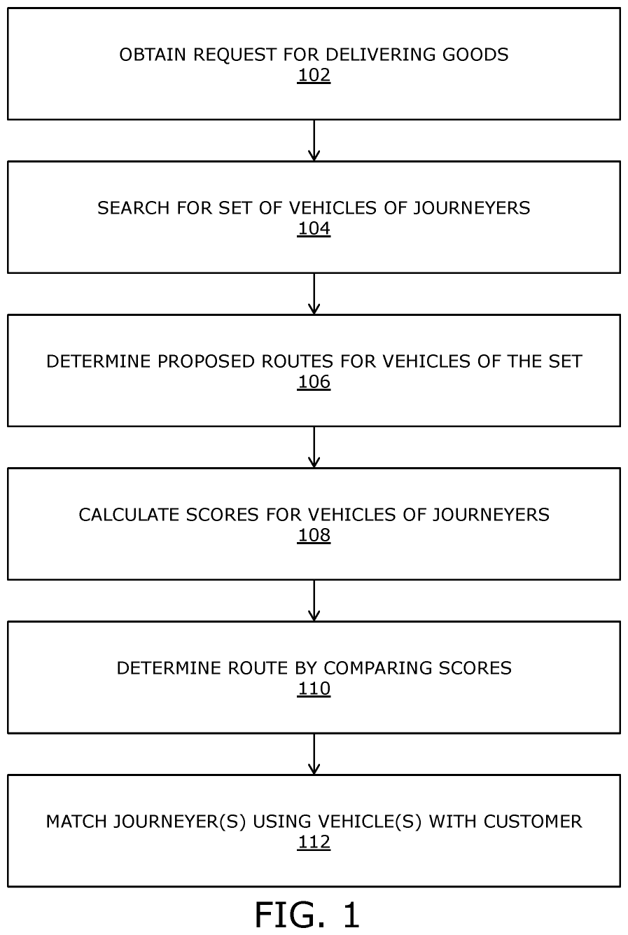

Referring to FIG. 1, there is provided an illustration of steps of a method for determining a route and at least one vehicle for delivering goods, according to an embodiment of the present disclosure. At a step 102, a request is obtained from a user device of a customer with goods to be delivered from a first location to a second location. At a step 104, there is searched a set of vehicles of journeyers in the vicinity of the first location and/or en-route to the second location and having a logistics capacity required for transporting the goods. At a step 106, a proposed route for delivering the goods is determined, for each vehicle in the set, using a geographical map of a region comprising the first location and the second location, and using geolocation data and/or a journey plan and/or logistics capacity and/or CO₂ emission data of said vehicle. At a step 108, a score is calculated for each vehicle of each journeyer who is able to deliver the goods from the first location to the second location, said score comprising a first value and a second value, wherein the first value is calculated based on one or more of simulated data, historical data, and live data for the proposed route, and wherein the second value is calculated based on one or more of: attributes of the vehicle that affect its carbon emissions, historical carbon emissions of the vehicle, length of the proposed route for the vehicle. At a step 110, the route to be used for delivering the goods is determined by comparing the calculated scores for proposed routes of the vehicles of the set. At a step 112, one or more journeyers traveling on the determined route using the at least one vehicle, are matched with the customer, for enabling delivery of the goods.

The aforementioned steps are only illustrative and other alternatives can also be provided where one or more steps are added, one or more steps are removed, or one or more steps are provided in a different sequence without departing from the scope of the claims herein.

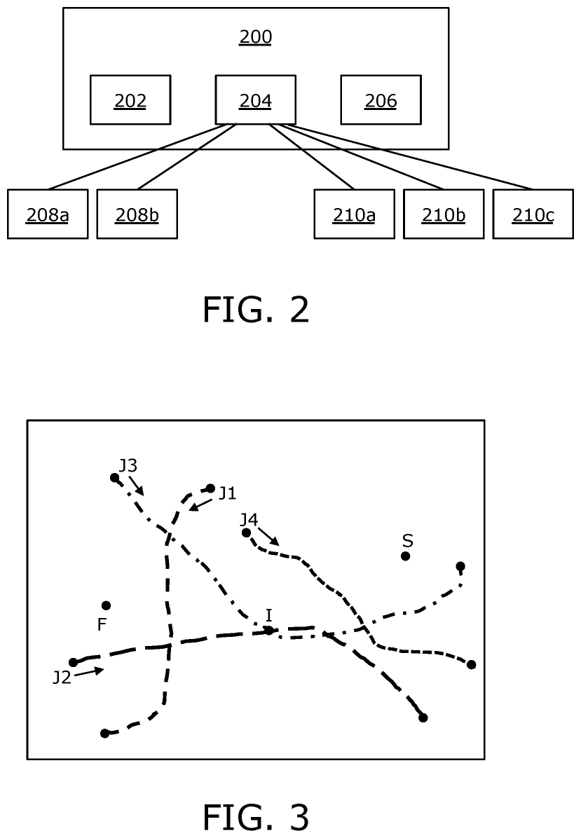

Referring to FIG. 2, there is provided an illustration as a block diagram of an architecture of a system 200 that is configured for determining a route and at least one vehicle for delivering goods, according to an embodiment of the present disclosure. The system 200 comprises a memory 202, a communication module 204, and a processor 206; these items are coupled together and configured to function as a data processing system The memory 202 is communicably coupled to the processor 206 via the communication module 204. The communication module 204 is capable of communicating with user devices of customers (depicted as user devices 208a, 208b) and user devices of journeyers (depicted as user devices 210a, 210b, 210c).

It may be understood by a person skilled in the art that the FIG. 2 includes a simplified architecture of the system 200 for sake of clarity, which should not unduly limit the scope of the claims herein. It is to be understood that the specific implementations of the system 200 are provided as examples and are not to be construed as limiting it to specific numbers or types of memory, and to specific numbers or types of communication modules. The person skilled in the art will recognize many variations, alternatives, and modifications of embodiments of the present disclosure.

Referring to FIG. 3, there is provided an illustration of an exemplary scenario of using a method for determining a route and at least one vehicle for delivering goods, according to an embodiment of the present disclosure. Herein, a request is obtained from a user device of a customer (not shown) with goods to be delivered from a first location ‘F’ to a second location ‘S’. Further, a set of vehicles of four journeyers J1, J2, J3, and J4 are searched, said vehicles being in a vicinity of the first location ‘F’ and/or en-route to the second location ‘S’ and having a logistics capacity required for transporting the goods. The four journeyers J1, J2, J3, and J4 are already travelling on routes as depicted using a dashed line, a long dashed line, a dashed dot line, and a square dot line, respectively. A direction of travelling of each journeyer is shown using an arrow. Thus, a proposed route for delivering the goods is determined for each vehicle in the set, using a geographical map of a region comprising the first location and the second location, and using geolocation data and/or a journey plan and/or logistics capacity and/or CO₂ emission data of said vehicle. The proposed route is for example, a route which is a combination of an original route of the journeyer and a detour that the journeyer is required to take for delivering the goods from the first location to the second location. Next, a score for each vehicle of each journeyer who is able to deliver the goods from the first location to the second location, is calculated. The score comprises a first value and a second value. Based on at least one of: simulated data, historical data, live data, first values (for example, in a range of 0 to 1) for the journeyers J1, J2, J3, and J4 are calculated as 0.2, 0.65, 0.7, and 0.4. Based on one or more of: attributes of the vehicle that affect its carbon emissions, historical carbon emissions of the vehicle, length of the proposed route for the vehicle, second values (for example, in a range of 0 to 1) for the journeyers J1, J2, J3, and J4 may also be calculated as 0.6, 0.7, 0.7, and 0.45. The scores for the journeyers J1, J2, J3, and J4, when computed according to the first and second values may be in the following descending order: J3, J2, J1, J4. Thus, the route to be used for delivering the goods, is determined by comparing the aforesaid scores for proposed routes of the vehicles of the set. Herein, the route is determined by combining proposed routes of the journeyers J3 and J2 having a highest and a second-highest score. Therefore, the journeyers J2 and J3 are matched on the determined route with the customer for delivering the goods, in a manner that the journeyer J2 would collect the goods from the first location ‘F’ and hand over the goods to the journeyer J3 at an intermediate location (for example, depicted as a location ‘I’) between the first location ‘F’ and the second location ‘S’, and the journeyer J3 would deliver said goods from the intermediate location ‘I’ to the second location ‘S’with a minimal detour and a minimal carbon footprint.

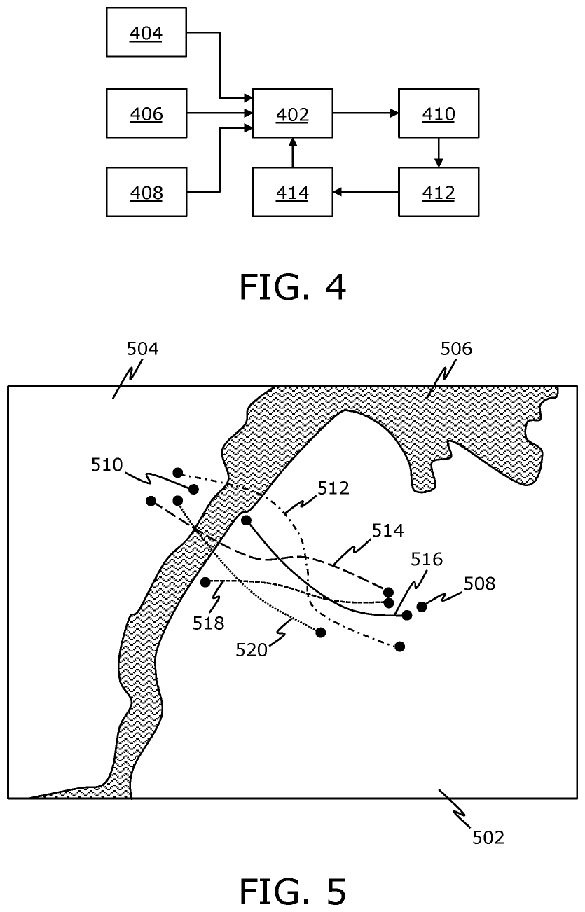

Referring to FIG. 4, there is provided an illustration of an exemplary process flow for learning and training an artificial intelligence (AI) model 402 to determine a route and at least one vehicle for delivering goods, according to an embodiment of the present disclosure. Firstly, interpreted simulated data 404, historical data 406, and live data 408 and their impact on route determination are sent to the AI model 402 to learn and train the AI model. Upon training, the AI model is capable of calculating a first value (which is a constituent of the score). Optionally, the AI model (or another AI model) may also be trained using at least one of: annotated fourth training data, annotated fifth training data, annotated sixth training data, and their corresponding second values, so that the AI model may learn to calculate a second value (which is a constituent of the score) based on one or more of: attributes of the vehicle that affect its carbon emissions, historical carbon emissions of the vehicle, length of the proposed route for the vehicle. Next at a step 410, the AI model performs an action by determining the route to be used for delivering the goods by comparing the calculated scores for proposed routes of the vehicles of the set, and matching one or more journeyers on the determined route using the at least one vehicle with a customer, for enabling delivering the goods. Further at a step 412, an environmental impact of the determined route is determined (by monitoring sensor data captured by a plurality of sensors) and recorded to improve route determination for future journeys. Then at a step 414, a reward function is also sent to the AI model, wherein the reward function corresponds to one or more factors (for example, CO₂ emissions, CO₂ pricing, service ratings, delivery time, logistics capacity, and social distancing measures) impacting the route determination.

FIGS. 3 and 4 are merely examples, which should not unduly limit the scope of the claims herein. The person skilled in the art will recognize many variations, alternatives, and modifications of embodiments of the present disclosure.

Referring to FIG. 5, there is provided an illustration of an experimental use-case scenario of using a method for determining a route for delivering goods, according to an embodiment of the present disclosure. Herein, a map of a city is shown, the city having two districts 502 and 504 separated by a water body 506. A request is obtained from a customer (not shown) with goods to be delivered from a first location 508 in the district 502 to a second location 510 in the district 504. Furthermore, a set of vehicles of five journeyers (with taxis) are searched, said vehicles being in a vicinity of the first location 508 and/or en-route to the second location 510 and having a logistics capacity required for transporting the goods. The five journeyers are travelling on routes as depicted using a dashed dot line 512, a long dashed line 514, a solid line 516, a square dot line 518, and a round dot line 520, respectively. Herein, the route is determined by considering a route of the first journeyer (as shown using the dashed dot line 512). Though the first journeyer would not be near the first location 508 and he/she has to take a detour, the first journeyer makes up for the detour at an end of a delivery trip having the second location 510 on a preferable and correct district (i.e., the district 504).

### EXPERIMENTAL DATA

Hereinbelow, there are provided results of an experiment conducted on a real-world scenario, using a dataset published by a licensing and regulatory body for taxi hirings in a city. Said dataset comprises information pertaining to trips taken via taxis in the city in a past few years. It was assumed that boot spaces of the taxis (underutilized logistics spaces of the taxis) were considerably spacious and thus could be used to store and deliver the goods according to steps of a method of the present disclosure. The dataset comprises information pertaining to a pick-up location and a drop-off location for each taxi trip. Such locations could be in the form of longitudes and latitudes. Moreover, the dataset further comprises information pertaining to at least one: a journeyer, a pick-up time, a drop-off time, a passenger count, a distance between the pick-up location and the drop-off location, a fare per unit distance, a total price paid by the customer, a service tax amount, a tip amount, a toll amount, a surcharge amount, a congestion charge amount, a journeyer rating, a customer rating, CO₂ emissions, a route followed for a past trip.

It will be appreciated that data cleansing technique and data pre-processing technique were applied to the dataset, prior to using the dataset for the method of the present disclosure. In this regard, fields in the dataset that were null (i.e., missing data) were removed. Moreover, when the null fields were less than 10 percent of a whole dataset, the null fields were highly unlikely to cause any bias in results. An average of immediate previous values was also utilized as values for the null fields because it was possible that an error value is returned when processing the null fields.

The data pre-processing technique that was applied to the dataset is a standard scaler. It normalizes each column in the dataset by removing a mean and scaling to a unit variance. A standard score of a sample ‘x’ was calculated as:

$$z = ( x - u ) / s$$

wherein u is mean, and s is a standard deviation, x is an input value, and z is a new value. When the data pre-processing technique utilized an Artificial Neural Network (ANN) model, such a model was used for small batches of data of the data set, because in such a case, weights of nodes in the ANN model are reduced, for example minimal.

Upon processing the dataset, the dataset was combined with randomly generated data pertaining to delivery requests made by a customer with goods to be delivered from a first location to a second location. Such a combined data was then fed into a system of the present disclosure which determines a route for delivering the goods using at least one artificial intelligence model, and matches one or more journeyers on the determined route with the customer for delivering the goods.

It was experimentally observed that 20000 delivery requests were obtained over a period of one month and 14 million taxi trips were made. Referring to FIG. 5, an experimental use-case scenario is illustrated to show that the method of the present disclosure is beneficial in determining the route for delivering the goods. It was also observed that for the 20000 delivery requests, the method enables in reducing over 7 tons of CO₂ emissions. Such a reduction does not account for the CO₂ emissions caused by delivery vehicles of the journeyers moving between orders and driving to a depot at the end of a day for the 20000 delivery requests. Therefore, reduction in the CO₂ emissions could be as high as a double of calculated CO₂ savings. This confirms that the method, and the system were performing well in terms of reducing carbon footprint, even with a complex landscape and road infrastructure of the city. Furthermore, when underutilized logistics spaces in private cars, vans, trucks, autonomous vehicles, drones, ships, airplanes, and the like are to be considered suitable for delivering the goods, a large portion of a delivery demand may potentially be met without any need for dedicated delivery vehicles and their corresponding journeys. It was observed that the at least one artificial intelligence model produced an F1 score of 0.84.

1.-14. (canceled)

15. A method of determining a route for at least one vehicle to be used for delivering goods, the method comprising steps of:
obtaining, by a processor, a request from a user device of a customer with goods to be delivered from a first location to a second location;
searching, by the processor, for vehicles of journeyers in the vicinity of the first location and/or en-route to the second location and having a logistics capacity required for transporting the goods;
determining, by the processor, an expected route for delivering the goods for each vehicle using a geographical map of a region comprising the first location and the second location, and using at least one of: geolocation data, a journey plan, logistics capacity, carbon emission data, of said vehicle;
calculating, by the processor, using at least one artificial intelligence model, a score for each vehicle of each journeyer who is able to deliver the goods from the first location to the second location, wherein the score is calculated based on previous learned information from artificial intelligence model and on one or more of: simulated data, historical data, and live data for the expected route, and a reward function that corresponds to one or more attributes of the vehicle that affect its carbon emissions, historical carbon emissions of the vehicle, amount of time to deliver the goods using the expected route for the vehicle, CO₂ pricing, service ratings, logistics capacity, and social distancing measures;
determining, by the processor, the route to be used for delivering the goods by comparing the calculated scores for expected routes of the vehicles;
matching, by the processor, one or more journeyers traveling on the determined route using the at least one vehicle with the customer, for enabling delivery of the goods;
observing an environmental impact of the determined route by monitoring sensor data, in real-time, captured by a plurality of sensors, while the at least one vehicle travels on the route for delivering the goods, wherein the plurality of sensors are arranged in the at least one vehicle; and
recording, by the processor, the observed environmental impact to improve the calculation of the second value that impacts the route determination for future journeys, wherein the observed environmental impact is used as feedback to improve future route determination, and wherein the at least one artificial intelligence model is dynamically updated based on the feedback.

16. The method of claim 15, wherein the simulated data comprises simulation results of the expected route of the vehicle of the journeyer from the first location to the second location for delivering the goods.

17. The method of claim 15, wherein the historical data comprises attributes of trips made between the first location and the second location in the past.

18. The method of claim 15, wherein the live data comprises real-world live information received from the user device of the customer and/or user devices of the journeyers that could impact the route determination.

19. The method of claim 15, further comprising interpreting the simulated data, the historical data, and the live data to learn their impact on route determination and training at least one artificial intelligence model using the learnt impact and at least one artificial intelligence algorithm to suggest at least one route between the first location and the second location.

20. The method of claim 15, further comprising:
obtaining journeyer attributes;
obtaining customer attributes;
creating artificial intelligence models by selecting different algorithms, parameters, and variables, wherein an evolutionary algorithm is used when selecting different hyperparameters of the at least one artificial intelligence model; and
continually training the at least one artificial intelligence model to perform at least one of: suggest at least one route between the first location and the second location, or suggest the one or more journeyers for matching with the customer.

21. The method of claim 20, wherein the journeyer attributes comprise planned journeys, transport type, past locations, vehicle information, logistics capacity, and preferences of the journeyer.

22. The method of claim 20, wherein the customer attributes comprise requested journeys, past locations, preferences, demographic data, and historical records.

23. The method of claim 15, further comprising providing, at a user device of the journeyer, additional requests from the user device of the customer that could impact the route taken by the journeyer.

24. A system for determining a route and at least one vehicle for delivering goods, the system comprising:
a memory for storing data of the system;
a communication module configured to communicate with a user device of a customer and with user devices of journeyers; and
a processor configured to:
obtain a request from the user device of the customer with goods to be delivered from a first location to a second location;
search for vehicles of journeyers in the vicinity of the first location and/or en-route to the second location and having a logistics capacity required for transporting the goods;
determine an expected route for delivering the goods for each vehicle using a geographical map of a region comprising the first location and the second location, and using at least one of: geolocation data, a journey plan, logistics capacity, and carbon emission data of said vehicle;
calculate, using at least one artificial intelligence model, a score for each vehicle of each journeyer who is able to deliver the goods from the first location to the second location, wherein the score is calculated based on previous learned information from artificial intelligence model and on one or more of: simulated data, historical data, and live data for the expected route, and a reward function that corresponds to one or more attributes of the vehicle that affect its carbon emissions, historical carbon emissions of the vehicle, amount of time to deliver the goods using the expected route for the vehicle, CO₂ pricing, service ratings, logistics capacity, and social distancing measures;
determine the route to be used for delivering the goods by comparing the calculated scores for the expected routes of the vehicles;
match one or more journeyers traveling on the determined route using the at least one vehicle with the customer, for enabling delivery of the goods;
observe an environmental impact of the determined route by monitoring sensor data, in real-time, captured by a plurality of sensors while the at least one vehicle travels on the route for delivering the goods, wherein the plurality of sensors are arranged in the at least one vehicle; and
record the observed environmental impact to improve the calculation of the second value that impacts the route determination for future journeys, wherein the observed environmental impact is used as feedback to improve future route determination, and wherein the at least one artificial intelligence model is dynamically updated based on the feedback.

25. A non-transitory computer-readable medium storing instructions which, when executed by a processor, cause the processor to perform the steps of claim 1.
